(19) United States
(12) Patent Application Publication
(10) Pub. No.: US 2013/0172457 A1
(43) Pub. Date: Jul. 4, 2013

(54) Phosphorus-Containing Mixtures, Processes for Preparing Them and Use Thereof

(71) Applicants: Harald Bauer, Kerpen (DE); Sebastian Hoerold, Diedorf (DE); Martin Sicken, Koeln (DE)

(72) Inventors: Harald Bauer, Kerpen (DE); Sebastian Hoerold, Diedorf (DE); Martin Sicken, Koeln (DE)

(73) Assignee: Clariant Finance (BVI) Limited, Tortola (VG)

(21) Appl. No.: 13/822,536

(22) PCT Filed: Sep. 13, 2011
(86) PCT No.: PCT/EP11/04597

§ 371 Date: Mar. 12, 2013

(30) Foreign Application Priority Data
Sep. 14, 2010 (DE) 10 2010 047 790.7

(51) Int. Cl. C07F 9/30

(52) U.S. Cl. CPC C07F 9/303
USPC 524/130; 562/8

(57) ABSTRACT

The invention provides phosphorus-containing mixtures comprising a) from 50 to 100 mol % of compounds of the formula (1)

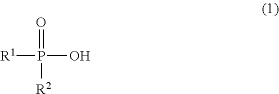

in which R¹ and R² are identical or different and are C₆-C₉-alkyl, b) 0 to 50 mol % of compounds of the formula (1) in which R¹ is H and R² is C₆-C₉-alkyl, c) 0 to 50 mol % of compounds of the formula (1) in which R¹ is OH and R² is C₆-C₉-alkyl, d) from 0 to 50 mol % of compounds of the formula (1) in which R¹ is OH and R² is H, and e) from 0 to 50 mol % of compounds of the formula (1) in which R¹ is H and R² is H, with the sum of a), b), c), d), and e) always being 100 mol %.

Phosphorus-containing mixtures, processes for preparing them and use thereof.

The present invention relates to phosphorus-containing mixtures, a process for producing them, and their use.

Phosphorus-containing mixtures with selected target products have hitherto been impossible or very difficult to produce.

By way of example, Petrov (Otd. Obshch. Tekh. Khim. (1967) 181-6) teaches the production of dicyclohexylphosphinic acid from sodium hypophosphite monohydrate and cyclohexene in methanol by adding portions of tert-Bu₂O₂, a lipophilic initiator, during 12 hours at elevated temperatures.

Nifant'ev (Zh.Obsh Khim 50 (1980) 1416; CAS 93:238169) teaches the production of dialkylphosphinic acids by reacting sodium hypophosphite with conc. sulfuric acid or acetic acid, an olefin (n-heptene, n-decene) and bisbenzoyl peroxide, likewise a lipophilic initiator, in water and dioxane. It therefore appears that water-ether mixtures and lipophilic initiators are a precondition for producing relatively long-chain phosphinic acids.

In the prior art, aqueous systems and hydrophilic initiators can be used only for gaseous short-chain open-chain olefins.

The teaching of the prior art is that relatively long-chain and cyclic olefins can undergo addition reactions onto the phosphorus atom only with lipophilic initiators. Considerable amounts of organic solvents are moreover needed.

No method has hitherto been described in which phosphinic acids bearing carbon chains are obtained directly from the reaction solution.

It is therefore an object of the present invention to provide phosphorus-containing mixtures themselves, and also a process for producing phosphorus-containing mixtures, in particular for producing mixtures of selected dialkylphosphinic acids.

It was therefore an object to avoid the disadvantages of the prior art with respect to the initiator and solvent system.

Surprisingly, it has been found that liquid long-chain olefins can also react in aqueous systems with free-radical initiation. Although hydrophilic and lipophilic free-radical generators can be used, preference is given to the hydrophilic free-radical generators.

It has moreover been found that the phosphorus-containing mixtures of the process of the invention can be isolated directly from the reaction solution, and that the synthesis is therefore very easy to operate.

In another embodiment of the invention, the isolation process uses no organic solvents.

In one particularly preferred embodiment this is achieved by liberating the (dialkyl)phosphinic acid without addition of acid.

The invention therefore provides phosphorus-containing mixtures comprising
a) from 50 to 100 mol % of compounds of the formula (1)

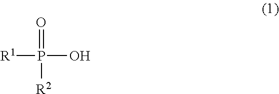

in which R¹ and R² are identical or different and are C₆-C₉-alkyl,
b) from 0 to 50 mol % of compounds of the formula (1) in which R¹ is H and R² is C₆-C₉-alkyl,
c) from 0 to 50 mol % of compounds of the formula (1) in which R¹ is OH and R² is C₆-C₉-alkyl,
d) from 0 to 50 mol % of compounds of the formula (1) in which R¹ is OH and R² is H, and
e) from 0 to 50 mol % of compounds of the formula (1) in which R¹ is H and R² is H,
   where the entirety of a), b), c), d), and e) always gives 100 mol %.

It is preferable that the mixtures comprise
a) from 50.10 to 99.9 mol % of compounds of the formula (1) in which R¹ and R² are identical or different and are C₆-C₉-alkyl,
b) from 0.05 to 24.95 mol % of compounds of the formula (1) in which R¹ is H and R² is C₆-C₉-alkyl, and
c) from 0.05 to 24.95 mol % of compounds of the formula (1) in which R¹ is H and R² is H,
   where the entirety of a), b), and c) always gives 100 mol %.

It is also preferable that the mixtures comprise
a) from 50.10 to 99.9 mol % of compounds of the formula (1) in which R¹ and R² are identical or different and are C₆-C₉-alkyl,
b) from 0.05 to 24.95 mol % of compounds of the formula (1) in which R¹ is OH and R² is C₆-C₉-alkyl, and
c) from 0.05 to 24.95 mol % of compounds of the formula (1) in which R¹ is OH and R² is H,
   where the entirety of a), b), and c) always gives 100 mol %.

In particular, the mixtures comprise
a) from 50.20 to 99.8 mol % of compounds of the formula (1) in which R¹ and R² are identical or different and are C₆-C₉-alkyl,
b) from 0.05 to 12.55 mol % of compounds of the formula (1) in which R¹ is H and R² is C₆-C₉-alkyl,
c) from 0.05 to 12.55 mol % of compounds of the formula (1) in which R¹ is OH and R² is C₆-C₉-alkyl,
d) from 0.05 to 12.55 mol % of compounds of the formula (1) in which R¹ is OH and R² is H, and
e) from 0.05 to 12.55 mol % of compounds of the formula (1) in which R¹ is H and R² is H,
   where the entirety of a), b), c), d), and e) always gives 100 mol %.

It is preferable that R¹ and R² are identical or different and are cyclic, isocyclic, open-chain, linear open-chain and/or branched open-chain C₆-C₈-alkyl.

It is preferable that R¹ and R² are identical or different and are pentyl, cyclopentyl, methylpentyl, methylcyclopentyl, dimethylpentyl, dimethylcyclopentyl, trimethylpentyl, trimethylcyclopentyl, hexyl, cyclohexyl, methylhexyl, methylcyclohexyl, dimethylhexyl, dimethylcyclohexyl, trimethylhexyl, and/or trimethylcyclohexyl.

The invention also provides a process for producing phosphorus-containing mixtures as claimed in at least one of claims 1 to 6, which comprises reacting a phosphinate source, an olefin which is liquid at room temperature (from 20 to 25° C.), and a free-radical initiator, in the presence of selectivity controllers in an aqueous medium.

It is preferable that an additive is moreover added.

It is preferable that the phosphinate source involves sodium hypophosphite, hypophosphorous acid, alkaline earth metal hypophosphite, elemental phosphorus, phosphorus trichloride, and/or another phosphinate source.

It is preferable that the liquid olefin involves pentene, cyclopentene, cyclopentadiene, hexene, methylhexene, dimethyl hexene, trimethylhexene, methylhexadiene, cyclohexene, methylcyclohexene, dimethylcyclohexene, 1,3-cyclohexadiene, methyl-1,3-cyclohexadiene, dimethyl-1,3-cyclohexadiene, trimethyl-1,3-cyclohexadiene, 1,4-cyclohexadiene, methyl-1,4-cyclohexadiene, dimethyl-1,4-cyclohexadiene, or any desired mixture thereof.

It is preferable that the selectivity controller involves organic phosphites, organic phosphonites, sterically hindered amines, aromatic amines, sterically hindered phenols, alkylated monophenols, phenothiazines, organosulfur compounds, alkylthiomethylphenols, tocopherols, alkylidenebisphenols, O-/N- and S-benzyl compounds, hydroxybenzylated malonates, hydroquinones, alkylated hydroquinones, hydroxylated thiodiphenyl ethers, alkylidene bisphenols, hydroxybenzylaromatics, triazine compounds, benzylphosphonates, acylaminophenols, esters of beta-(3,5-di-tert-butyl-4-hydroxyphenyl)propionic acid with mono- or polyhydric alcohols, esters of beta-(5-tert-butyl-4-hydroxy-3-methylphenyl)propionic acid with mono- or polyhydric alcohols, esters of beta-(3,5-dicyclohexyl-4-hydroxyphenyl)propionic acid with mono- or polyhydric alcohols, esters of 3,5-di-tert-butyl-4-hydroxyphenylacetic acid with mono- or polyhydric alcohols, and/or amides of beta-(3,5-di-tert-butyl-4-hydroxyphenyl)propionic acid.

It is preferable that the free-radical initiator involves water-soluble peroxo compounds or azo compounds.

It is preferable that the peroxo compounds involve potassium persulfate, sodium persulfate, ammonium persulfate, potassium peroxomonosulfate, sodium peroxomonosulfate, ammonium peroxomonosulfate, hydrogen peroxide, benzoyl peroxide, di-tert-butyl peroxide, dicumyl peroxide, 2,4-dichlorobenzoyl peroxide, decanoyl peroxide, lauryl peroxide, cumene hydroperoxide, pinene hydroperoxide, p-menthane hydroperoxide, tert-butyl hydroperoxide, acetylacetone peroxide, methyl ethyl ketone peroxide, succinic acid peroxide, dicetyl peroxydicarbonate, tert-butyl peroxyacetate, tert-butyl peroxymaleic acid, tert-butyl peroxybenzoate, acetylcyclohexylsulfonyl peroxide, performic acid, peracetic acid, 2,4-dichlorobenzoyl peroxide, and/or decanoyl peroxide.

It is preferable that the azo compounds involve
2,2′-azobis[2-(5-methyl-2-imidazolin-2-yl)propane]dihydrochloride,
2,2′-azobis[2-(2-imidazolin-2-yl)propane]dihydrochloride,
2,2′-azobis[2-(2-imidazolin-2-yl)propane disulfate dihydrate,
2,2′-azobis(2-amidinopropane) hydrochloride,
2,2′-azobis[N-(2-carboxyethyl)-2-methylpropionamidine]tetrahydrate,
2,2′-azobis[2-(3,4,5,6-tetrahydropyrimidin-2-yl)propane]dihydrochloride,
2,2′-azobis{2-[1-(2-hydroxyethyl)-2-imidazolin-2-yl]propane}dihydrochloride,
2,2′-azobis[2-(2-imidazolin-2-yl)propane],
2,2′-azobis{2-methyl-N-[1,1-bis(hydroxymethyl)-2-hydroxyethyl]propionamide,
2,2′-azobis{2-methyl-N-[2-(1-hydroxybutyl)]propionamide} and/or
2,2′-azobis[2-methyl-N-(2-hydroxyethyl)propionamide].

The process of the invention is moreover one wherein, after the reaction, the resultant mixture is worked up by
a) admixing mineral acid with the reaction solution, and
b) isolating the mixture then obtained and then at least one of the following steps is implemented
c) washing the mixture with water
d) drying the mixture
e) grinding the mixture
f) sieving the mixture.

In another embodiment, after the reaction, the resultant mixture is worked up by
a) admixing mineral acid with the reaction solution, and
b) admixing solvent with the reaction solution, and isolating the resultant solvent phase,
   and then at least one of the following steps is implemented
c) extracting the solvent phase with water
d) concentrating the solvent phase and crystallizing the mixture
e) isolating the mixture
f) washing the mixture with water
g) drying the mixture
h) grinding the mixture
i) sieving the mixture.

In another embodiment, after the reaction, the resultant mixture is worked up by
a) admixing mineral acid with the reaction solution
b) isolating the solid
c) concentrating the reaction solution by evaporation, and
d) admixing solvent with the resultant residue from concentration by evaporation
   and then at least one of the following steps is implemented
e) extracting the solvent phase with water
f) concentrating the solvent phase and crystallizing the resultant mixture
g) isolating the mixture
h) drying the mixture
i) grinding the mixture
j) sieving the mixture.

In another process variant, after the reaction, the resultant mixture is worked up by
a) concentrating the reaction solution by evaporation
b) admixing solvent
c) admixing mineral acid with the reaction solution
d) filtering the solid off from the solvent phase
e) concentrating the solvent phase by evaporation
f) admixing solvent with the resultant residue from concentration by evaporation
   and then at least one of the following steps is implemented
g) extracting solvent phase 2 with water
h) concentrating solvent phase 2 and crystallizing the mixture
i) drying the mixture
j) grinding the mixture
k) sieving the mixture.

The invention also provides a flame-retardant plastics molding composition comprising a phosphorus-containing mixture as claimed in one or more of claims 1 to 6, wherein the plastic involves thermoplastic polymers of the type of HI (high-impact) polystyrene, polyphenylene ethers, polyamides, polyesters, polycarbonates, and blends or polymer blends of the type of ABS (acrylonitrile-butadiene-styrene) or PC/ABS (polycarbonate/Acrylonitrile-butadiene-styrene), polypropylene, polymethyl methacrylate (PMMA), XPS (extruded rigid polystyrene foam), EPS (expanded polystyrene), or PPE/HIPS (polyphenylene ether/HI polystyrene) plastics, and wherein it comprises from 50 to 98% by weight of plastics molding composition and from 2 to 50% by weight of the phosphorus-containing mixture as claimed in one or more of claims 1 to 6.

The invention likewise provides polymer moldings, polymer films, polymer filaments, and polymer fibers comprising a phosphorus-containing mixture as claimed in one or more of claims 1 to 6, wherein the polymer involved HI (high-impact) polystyrene, polyphenylene ethers, polyamides, polyesters, polycarbonates, and blends or polymer blends of the type of ABS (acrylonitrile-butadiene-styrene) or PC/ABS (polycarbonate/acrylonitrile-butadiene-styrene), polyamide, polyester, polypropylene, polymethyl methacrylate (PMMA), XPS (extruded rigid polystyrene foam), EPS (expanded polystyrene), and/or ABS, and wherein it comprises from 50 to 98% by weight of polymer molding, polymer films, polymer filaments, and/or polymer fibers and from 2 to 50% by weight of the phosphorus-containing mixture as claimed in one or more of claims 1 to 6.

Preferred C₆-C₉-alkyl substituents are cyclic, isocyclic, open-chain, linear open-chain, and branched open-chain substituents.

Preferred C₆-C₉-alkyl substituents are C₆-C₉-n-alkyl, -alkylcycloalkyl, -dialkylcycloalkyl, and -trialkylcycloalkyl.

Preferred C₆-C₉-alkyl substituents are pentyl, cyclopentyl, methylpentyl, methylcyclopentyl, dimethylpentyl, dimethylcyclopentyl, trimethylpentyl, trimethylcyclopentyl, hexyl, cyclohexyl, methylhexyl, methylcyclohexyl, dimethylhexyl, dimethylcyclohexyl, trimethylhexyl, and trimethylcyclohexyl.

Surprisingly, it has been found that mixtures of the invention are superior in flame retardancy to the mixture-free substance which 100 mol % of compounds of the formula (1) in which R¹ and R² are identical or different and are C₆-C₉-alkyl.

Whereas pure phosphinic acid is not a successful flame retardant at concentrations of up to 10% in PMMA, PP, nylon, PS, PS-butadiene, and ABS (DE-A-1 933 396), a flame retardancy classification can be obtained with the mixtures of the invention.

Preference is given to mixtures comprising compounds of the formula (1) in which R¹ and R² are identical or different and are C₆-C₉-alkyl with compounds of the formula (1) in which R¹ is OH and R² is C₆-C₉-alkyl.

Preference is also given to mixtures comprising compounds of the formula (1) in which R¹ and R² are identical or different and are C₆-C₉-alkyl with compounds of the formula (1) in which R¹=OH and R²=H.

Preference is also given to mixtures comprising compounds of the formula (1) in which R¹ and R² are identical or different and are C₆-C₉-alkyl with compounds of the formula (1) in which R¹=H and R²=H.

Preference is also given to mixtures comprising compounds of the formula (1) in which R¹ and R² are identical or different and are C₆-C₉-alkyl with compounds of the formula (1) in which R¹=OH and R²=C₆-C₉-alkyl and with compounds of the formula (1) in which R¹=OH and R²=H.

It is preferable that the phosphorus content of the mixture of the invention is from 12.5 to 15% by weight.

It is preferable that the particle size of the mixture of the invention is from 0.1 to 1000 μm.

It is preferable that the bulk density of the mixture of the invention is from 80 to 800 g/l, particularly from 200 to 700 g/l.

It is preferable that the content of initiator end groups in the mixture of the invention is from 0.0001 to 10 mol % by, particularly from 0.001 to 1 mol %. During free-radical chain termination, initiator end groups can remain bonded to the final molecule of the free-radical chain.

It is preferable that the L chromaticity coordinate of the mixture of the invention is from 85 to 99.9, particularly from 90 to 98.

It is preferable that the a chromaticity coordinate of the mixture of the invention is from −4 to +9, particularly from −2 to +6.

It is preferable that the b chromaticity coordinate of the mixture of the invention is from −2 to +6, particularly from −1 to +3.

The chromaticity coordinates are stated in the Hunter system (CIE-LAB-System, Commission Internationale d'Eclairage). L coordinates range from 0 (black) to 100 (white), a coordinates range from −a (green) to +a (red), and b coordinates range from −b (blue) to +b (yellow).

It is also possible, as an alternative, to form the phosphinate source by reacting a phosphinate salt with acid. It is preferable that this is achieved by selecting a suitable pH in the reaction solution. The pH of the reaction solution is preferably from 1 to 10, very particularly preferably from 2 to 6.

As an alternative, it is possible to form the olefin source by reacting precursor substances. The olefin source can preferably be formed by dehydrating open-chain, branched open-chain, or cyclic alcohols, e.g. hexanol, heptanol, octanol, nonanol, 2-ethyl-1-hexanol, 3-methyl-3-hexanol, cyclohexanol, methylcyclohexanol, cyclopentanol, and/or methylcyclopentanol, or 1-methylcyclopentanol.

Preferred reaction conditions are temperatures from 0 to 300° C., particularly from 50 to 170° C., and reaction times of from 10⁻⁷ to 10² h. The pressure can vary from 1 to 200 MPa (=from 0.00001 to 200 bar), preferably from 10 Pa to 10 MPa.

Preference is given to energy input of from 0.083 to 10 kW/m³, particularly from 0.33 to 1.65 kW/m³.

The phosphorus-containing mixture of the invention can be isolated by various methods, described in claims 14 to 17.

It was found that no further use of organic solvents is necessary. Surprisingly, in the process of claim 14, the phosphorus-containing mixture of the invention precipitates completely from water.

When mineral acid is admixed with the reaction solution, this is preferably hydrochloric acid, sulfuric acid, or phosphoric acid. It is preferable to use acidic double salt (e.g. sodium bisulfate). It is preferable that the acidic double salt forms from the initiator.

It is preferable that pH is from 0 to 5 when material is admixed with the reaction solution.

When the phosphorus-containing mixture of the invention is washed with water, the water/product ratio is from 1150 mol/1 mol to 1 mol/1 mol.

When the phosphorus-containing mixture of the invention is dried, the conditions are preferably from 20 to 250° C. and from 1 mbar to 6 bar.

In the isolation process in claim 15, it is preferable that the solvent is heptane, the olefin used, or acetic acid.

In the isolation process in claim 16 or 17, the solvent is preferably acetic acid.

The phosphinate source serves to supply the phosphorus atom. During the course of the reactions, two olefin molecules form an adduct with the phosphorus atom. As an alternative, the phosphinate source can be oxidized by the initiator used to give phosphite.

As an alternative, only one olefin molecule can form an adduct, and the reaction product can be oxidized to give phosphonate. The formation of compounds of the formula (1) in which R¹ is H and R² is C₆-C₉-alkyl, in which R¹ is OH and R² is C₆-C₉-alkyl, in which R¹ is OH and R² is H and in which R¹ is H and R² is H can be regulated by selectivity controllers.

It is preferable that the phosphorus-containing compound (phosphinate source) involves hypophosphorus acid and/or its salts or esters.

Hypophosphorus acid can preferably be produced from suitable salts, by reacting with acids. Suitable salts are those having cations of the 1st main group, and cations of the 2nd main group and nitrogen bases.

Suitable cations of the 1st main group are sodium and potassium.

Suitable cations of the 2nd main group are calcium and magnesium.

Suitable nitrogen bases are ammonium and anilinium.

Hypophosphorus acid or its salts can preferably be produced by hydrolyzing trivalent phosphorus compounds, e.g. phosphorus trichloride.

hypophosphorous acid or its salts can preferably be produced by alkaline hydrolysis from elemental phosphorus.

Hypophosphorous acid can preferably be used in a mixture with water. The ratio of H₂O to P is then preferably from 33 mol:1 mol to 0.0004 mol:1 mol, particularly preferably from 3.7:1 to 0.4:1.

The phosphinate source can preferably be used or, respectively, added in a mixture with solvent (water), selectivity controller, or initiator.

Suitable olefins are relatively long-chain or are cyclic, liquid at room temperature (from 20 to 25° C.) and have low solubility in water. It is preferable that solubility is less than 1 g/l at 20° C.

Examples of preferred hexenes are hex-1-ene, hex-2-ene, hex-3-ene, 2-methylpent-1-ene, 2-methylpent-2-ene, 2-methylpent-3-ene, 2-methylpent-1-ene, 3-methylpent-1-ene, 3-methylpent-2-ene, 3-methylpent-3-ene, 1,1-dimethylbut-3-ene, 1,3-but-1-ene, 1,3-but-3-ene.

Examples of preferred trimethylhexenes are 4,5,5-trimethyl-2-hexene, (Z)-2,2,4-trimethyl-3-hexene, 3,5,5-trimethyl-1-hexene, 4,5,5-trimethyl-2-hexene, 3,4,5-trimethyl-1-hexene, 2,2,5-trimethyl-3-hexene, 2,4,4-trimethyl-2-hexene, 4,4,5-trimethyl-2-hexene, 3,3,4-trimethyl-1-hexene, 2,2,4-trimethyl-3-hexene, 3,4,4-trimethyl-2-hexene, 3,4,4-trimethyl-1-hexene, 4,5,5-trimethyl-2-hexene, 2,2,3-trimethyl-3-hexene, 3,5,5-trimethyl-(3R)-1-hexene, (Z)-2,2,5-trimethyl-3-hexene, 2,4,4-trimethyl-1-hexene, 3,4,5-trimethyl-2-hexene, trimethylhexene, 2,3,3-trimethyl-1-hexene, (R*,S*)-3,4,5-trimethyl-1-hexene, (Z)-4,5,5-trimethyl-2-hexene, (R*,R*)-3,4,5-trimethyl-1-hexene, (3E)-2,3,5-trimethyl-3-hexene, trimethyl-1-hexene, 2,5,5-trimethyl-2-hexene, (3Z)-2,3,5-trimethyl-3-hexene, (3E)-2,2,5-trimethyl-3-hexene, 2,4,5-trimethyl-2-hexene, 2,3,5-trimethyl-3-hexene, (Z)-3,5,5-trimethyl-2-hexene, 2,3,5-trimethyl-2-hexene, trimethyl-2-hexene, (E)-3,5,5-trimethyl-2-hexene, 3,5,5-trimethyl-2-hexene, 2,3,3-trimethylhexene, 3,3,4-trimethylhexene, 2,3,4-trimethyl-2-hexene, 2,3,5-trimethylhexene, 2,3,4-trimethylhexene, (E)-2,3,4-trimethyl-3-hexene, 2,2,4-trimethylhexene, 4,4,5-trimethyl-1-hexene, (Z)-2,3,4-trimethyl-3-hexene, 2,2,5-trimethylhexene, 2,5,5-trimethyl-1-hexene, 4,5,5-trimethyl-1-hexene, 2,4,5-trimethyl-1-hexene, (E)-2,2,4-trimethyl-3-hexene and/or 3,3,5-trimethyl-1-hexene.

Examples of preferred methylhexadienes are methyl-1,3-hexadiene, (E)-2-methyl-1,4-hexadiene, (S)-4-methyl-2,3-hexadiene, 3-methyl-1,3-hexadiene, (R)-4-methyl-2,3-hexadiene, (E)-2-methyl-1,3-hexadiene, (Z,Z)-3-methyl-2,4-hexadiene, methyl-1,4-hexadiene, (3S)-3-methyl-1,4-hexadiene, (4E)-2-methyl-2,4-hexadiene, 3-methyl-1,4-hexadiene, (E)-3-methyl-1,4-hexadiene, 5-methyl-1,3-hexadiene, 4-methyl-1,2-hexadiene, 3-methyl-1,2-hexadiene, 2(or 3)-methyl-2,4-hexadiene, (Z)-5-methyl-1,4-hexadiene, (3E)-3-methyl-1,3-hexadiene, (Z)-4-methyl-1,3-hexadiene, (2E,4Z)-3-methyl-2,4-hexadiene, 3-methylhexadienes, (3Z)-3-methyl-1,3-hexadiene, (4Z)-2-methyl-2,4-hexadiene, 4-methyl-1,4-hexadiene, 2-methyl-1,3-hexadiene, 2-methyl-1,5-hexadiene, (3Z)-5-methyl-1,3-hexadiene, 4-methylene-2-hexadiene, (Z)-3-methyl-1,4-hexadiene, [S-(E)]-3-methyl-1,4-hexadiene, (3E)-4-methyl-1,3-hexadiene, 4(or 5)-methyl-1,4-hexadiene, 2-methyl-2,4-hexadiene, 4-methylene-1-hexadiene, (3E)-5-methyl-1,3-hexadiene, 2-methyl-1,4-hexadiene.

Examples of preferred methylcyclohexenes are 1-methylcyclohex-2-ene and 1-methylcyclohex-1-ene.

Examples of preferred dimethylcyclohexenes are dimethylcyclohex-1-ene, 1.3-dimethylcyclohex-4-ene, 1,2-dimethylcyclohex-1-ene, 1,3-dimethylcyclohex-1-ene, 1,4-dimethylcyclohex-1-ene, 1,2-dimethylcyclohex-4-ene, (1S,2S)-1,2-dimethylcyclohex-4-ene, 1,6-dimethylcyclohex-1-ene, 1,3-dimethylcyclohex-3-ene, 4,4-dimethylcyclohexenes, cis-3,5-dimethylcyclohexene, trans-3,5-dimethylcyclohexene, trans-1,2-dimethylcyclohex-4-ene, 3,3-dimethylcyclohex-1-ene, cis-1,2-dimethylcyclohex-4-ene, (3S,5R)-3,5-dimethylcyclohexene, (3S,5S)-3,5-dimethylcyclohexene, 2,3-dimethylcyclohexene, (3R,6R)-trans-3,6-dimethylcyclohexene, cis-3,6-dimethylcyclohexenes, 3r4c-dimethylcyclohex-1-ene, 3r.4t-dimethylcyclohex-1-ene, 1,3-dimethylcyclohex-1-enes, trans-1,2-dimethylcyclohex-4-ene, 1,3-dimethylcyclohex-3-ene, 3,6-dimethylcyclohexene, trans-3,6-dimethylcyclohexene, cis-3,4-dimethylcyclohex-1-ene, cis- and trans-3,5-dimethylcyclohexene, cis-3,5-dimethylcyclohex-1-ene, (S)-1,6-dimethyl-1-cyclohexenes, trans-3,4-dimethylcyclohexenes, 3,(4R)-dimethylcyclohexene, (3S,4R)-3,4-dimethylcyclohexene, 3,4-dimethylcyclohexene.

Examples of preferred methyl-1,3-cyclohexadienes are 1-methyl-2,4-cyclohexadiene, 1-methyl-1,3-cyclohexadiene, 2-methyl-1,3-cyclohexadiene. Examples of preferred dimethyl-1,3-cyclohexadienes are 1,6-dimethyl-1,3-cyclohexadiene, 1,3-dimethyl-1,3-cyclohexadiene, 2,6-dimethyl-1,3-cyclohexadiene, 5,5-dimethyl-1,3-cyclohexadiene, 5,6-dimethyl-1,3-cyclohexadiene, cis-5,6-dimethyl-1,3-cyclohexadiene, 2,5-dimethyl-1,3-cyclohexadiene, (S)-2,5-dimethyl-1,3-cyclohexadiene, 1,5-dimethyl-1,3-cyclohexadienes, 1,4-dimethyl-1,3-cyclohexadiene, trans-5,6-dimethyl-1,3-cyclohexadiene, 2,3-dimethyl-1,3-cyclohexadiene.

Examples of preferred trimethyl-1,3-cyclohexadienes are 1,6,6-trimethyl-1,3-cyclohexadiene, 1,2,3-trimethyl-1,3-cyclohexadiene, 2,5,5-trimethyl-1,3-cyclohexadiene, 2,6,6-trimethyl-1,3-cyclohexadiene, 5,5,6-trimethyl-1,3-cyclohexadiene, 1,5,5-trimethyl-1,3-cyclohexadiene, 1,2,4-tri methyl-1,3-cyclohexadiene, 1,3,6-trimethyl-1,3-cyclohexadiene, 1,3,5-trimethyl-1,3-cyclohexadiene, 1,6,6-trimethyl-1,4-cyclohexadiene, 1,3,3-trimethyl-1,4-cyclohexadiene, 1,2,4-trimethyl-1,4-cyclohexadiene, 3,3,6-trimethyl-1,4-cyclohexadiene, 1,3,5-trimethyl-1,4-cyclohexadiene.

Examples of preferred methyl-1,4-cyclohexadienes are 2-methyl-1,3-cyclohexadiene and 1-methyl-1,4-cyclohexadiene.

Examples of preferred dimethyl-1,4-cyclohexadienes are dimethyl-1,4-cyclohexadiene, 1,3-dimethyl-1,4-cyclohexadiene, cis-3,6-dimethyl-1,4-cyclohexadiene, 1,4-dimethyl-1,4-cyclohexadiene, trans-3,6-dimethyl-1,4-cyclohexadiene, 1,5-dimethyl-1,4-cyclohexadiene, 1,2-dimethyl-1,4-cyclohexadiene, 1,6-dimethyl-1,4-cyclohexadiene, 3,6-dimethyl-1,4-cyclohexadiene.

The olefins used in the invention can preferably be produced from precursor substances which can by way of example be tert-butanol or cyclohexanol. Production via dehydration can take place without or preferably with catalysts which can by way of example be aliphatic or aromatic sulfonic acids, e.g. benzenesulfonic acid or toluenesulfonic acid, dodecylbenzenesulfonic acid, sulfuric acid, or sulfuric hemiesters, such as alkyl sulfuric acid, phosphoric acid or its partially esterified derivatives, or boric acid and its acidic derivatives. Preference is given to anhydrides, such as phosphorus pentoxide, sulfur dioxide and boron oxide, aluminum oxide, aluminum phosphate, boron phosphate, aluminum silicate, silica gel, titanium oxide, heteropolyacids of phosphorus, and molybdic acid and tungstic acid.

Olefins of the invention can preferably be produced from precursor substances at temperatures of from 50 to 600° C., or from 150 to 350° C.

The olefins can preferably be used or, respectively, added in a mixture with selectivity controllers or initiator.

Additives can be cosolvents, emulsifiers, dispersing agents, and/or surfactants.

Preferred cosolvents are alcohols, e.g. methanol, ethanol, isopropanol, n-propanol, n-butanol, isobutanol, tert-butanol, n-amyl alcohol, isoamyl alcohol, tert-amyl alcohol, n-hexanol, n-octanol, isooctanol, n-tridecanol, benzyl alcohol, cyclohexanol, etc. Preference is moreover given to glycols, e.g. ethylene glycol, 1,2-propanediol, 1,3-propanediol, 1,3-butanediol, 1,4-butanediol, diethylene glycol, polyethylene glycols, and their ethers, and/or benzoic acid, etc. It is preferable that the cosolvent is formed from the free-radical initiator.

Examples of preferred emulsifiers are alkali metal salts of alkyl- or alkylarylsulfonic acids, or are alkyl sulfates, fatty alcohol sulfonates, salts of higher fatty acids having from 10 to 30 carbon atoms, e.g. potassium stearate and sodium stearate, sodium lauryl sulfate, sodium oleates, sodium dodecylbenzenesulfonate, sodium rosinate, sodium laurate, sulfosuccinates, ether sulfonates, resin soaps; cationic surfactants, e.g. cetyltrimethylammonium bromide and dodecylamine chloride; nonionic surfactants, e.g. nonyl polyoxyethylene ethers and octylphenyl polyoxyethylene ethers, etc. These emulsifying agents can be used alone or in a mixture with one another.

The invention uses from 0.01 to 10% by weight of emulsifier, based on the amount of phosphorus used, preferably from 0.1 to 1% by weight of emulsifier.

Preferred dispersing agents are alkali metal salts of the sulfuric hemiesters of saturated and unsaturated fatty alcohols (from C₁₂ to C₂₀), alkali metal salts of alkylsulfonic acids (from C₁₂ to C₁₈), of sulfuric hemiesters of ethoxylated alkylphenols (number of E0 units: from 3 to 30, alkyl moiety: from C₈ to CO, and other preferred dispersing agents are ethoxylated fatty alcohols (number of E0 units: from 5 to 50, alkyl moiety: from C₈ to C₂₅) and ethoxylated alkylphenols (number of E0 units: from 3 to 30, alkyl moiety: C₈ to C₁₀).

Examples of preferred surfactants are alkyl alkoxylates (fatty alcohol ethoxylates), alkyl polyglycosides and anionic surfactants.

Preferred anionic surfactants of sulfonate type are (C₉ to C₁₃)-alkylbenzenesulfonates, alpha-olefinsulfonates, alkanesulfonates, fatty alcohol sulfates, fatty alcohol ether sulfates.

Preferred polyphosphates are disodium hydrogendiphosphate, trisodium hydrogendiphosphate, tetrasodium hydrogendiphosphate, tetrapotassium diphosphate, dicalcium diphosphate, calcium dihydrogendiphosphate, pentasodium triphosphate, and/or pentapotassium triphosphate.

Additives serve to improve the isolation process for the phosphorus-containing mixtures of the invention. They can preferably be used in a mixture with initiator, selectivity controller, olefin, or solvent.

### Acidic Double Salts

Preferred amount is from 0.1 to 50 mol % per mole of phosphorus.

It is preferable that the molar ratio of olefin to phosphinate source is from 10:1 to 2:1.

It is preferable that the molar ratio of water to phosphinate source is from 100:1 to 0.08:1, particularly from 10:1 to 0.3:1.

It is preferable that the molar ratio of initiator to phosphinate source is from 0.01:1 to 0.5:1, particularly from 0.05:1 to 0.25:1.

The amount of free-radical initiator metered into the system per hour in the invention (based on the starting phosphorus component) is from 0.001 to 50 mol %.

It is preferable that the molar ratio of additive to phosphinate source is from 50:1 to 0.0001:1, particularly from 20:1 to 0.001:1.

Preferred solvents are olefins of the invention or their precursors, water, alcohols, e.g. methanol, n-propyl alcohol, isopropyl alcohol, n-butanol, isobutanol, amyl alcohol, etc. Preference is further given to aliphatic hydrocarbons, such as hexane, heptane, octane, and petroleum ether;

aromatic hydrocarbons, such as benzene, toluene, xylene, ethylbenzene, diethylbenzene, and chlorobenzene; halogenated hydrocarbons, such as methylene chloride, chloroform, 1,2-dichloroethane, chlorobenzene, etc., carbon tetrachloride, tetrabromoethylene;
alicyclic hydrocarbons, such as cyclopentane, cyclohexane, and
methylcyclohexane; ketones, such as diisobutyl ketone and methyl n-propyl ketone; esters, such as n-propyl acetate and n-butyl acetate, etc. One or more of these compounds can be used alone or in combination.

It is particularly preferable to use water as solvent or dispersion medium. If, by way of example, alcohols such as butanol etc. are used as solubilizer or dispersing agent, subordinate amounts thereof are used, i.e. a proportion below 50%.

Suitable free-radical initiators are in principle any of the systems which generate free radicals. The addition of the olefin can be initiated by an anionic initiator or free-radical initiator, or photochemically.

Preference is given to water-soluble free-radical initiators.

Preferred free-radical initiators are benzoyl peroxide, di-tert-butyl peroxide, dicumyl peroxide, 2,4-dichlorobenzoyl peroxide, decanoyl peroxide, lauryl peroxide, cumene hydroperoxide, pinene hydroperoxide, p-menthane hydroperoxide, tert-butyl hydroperoxide, acetylacetone peroxide, methylethylketone peroxide, succinic acid peroxide, dicetyl peroxydicarbonate, tert-butylperoxyacetate, tert-butyl peroxymaleic acid, tert-butyl peroxybenzoate, acetylcyclohexylsulfonyl peroxide, performic acid, peracetic acid, 2,4-dichlorobenzoyl peroxide, and decanoyl peroxide.

Particularly preferred free-radical initiators are compounds which can form peroxides in the solvent system, for example sodium peroxide, sodium peroxide diperoxohydrate, sodium peroxide diperoxohydrate hydrate, sodium peroxide dihydrate, sodium peroxide octahydrate, lithium peroxide, lithium peroxide monoperoxohydrate trihydrate, calcium peroxide, strontium peroxide, barium peroxide, magnesium peroxide, zinc peroxide, potassium hyperoxide, potassium peroxide diperoxohydrate, sodium peroxoborate tetrahydrate, sodium peroxoborate trihydrate, sodium peroxoborate monohydrate, anhydrous sodium peroxoborate, potassium peroxoborate peroxohydrate, magnesium peroxoborate, calcium peroxoborate, barium peroxoborate, strontium peroxoborate, potassium peroxoborate, peroxomonophosphoric acid, peroxodiphosphoric acid, potassium peroxodiphosphate, ammonium peroxodiphosphate, potassium ammonium peroxodiphosphates (double salt), sodium carbonate peroxohydrate, urea peroxohydrate, ammonium oxalate peroxide, barium peroxide peroxohydrate, barium peroxide peroxohydrate, calcium hydrogen peroxides, calcium peroxide peroxohydrate, ammonium triphosphate diperoxophosphate hydrate, potassium fluoride peroxohydrate, potassium fluoride triperoxohydrate, potassium fluoride diperoxohydrate, sodium pyrophosphate di peroxohydrate, sodium pyrophosphate diperoxohydrate octahydrate, potassium acetate peroxohydrate, sodium phosphate peroxohydrate, sodium silicate peroxohydrate.

Selectivity controllers serve for correct adjustment of the composition of the mixtures of the invention. Incorrect selection of the starting materials can generally lead to production of excessive contents of by-product (oxidation reactions). These can cause side-effects during the production of the polymer molding compositions and polymer moldings, an example being liberation of phosphine.

Preferred selectivity controllers used are amounts of from 0.1 to 1000 ppm of transition metals. Preferred ions derive from manganese, silver, platinum, nickel, chromium, palladium, copper, vanadium, molybdenum, cobalt, or iron.

It is preferable that these transition metal ions are used in the form of salts of organic acids, where suitable organic acids in this context comprise from 2 to 20 carbon atoms and are those selected from the group of acetic acid, propionic acid, 2-ethylhexanoic acid, hexanoic acid, octanoic acid, oleic acid, oleic acid, palmitic acid, stearic acid, and naphthalenic acid. Complexes of salts of this type with acetoacetone are moreover suitable. (EP-A-1 622 945).

Preference is given to elements of transition group VIII of the periodic table of the elements. Particular preference is given to iron, in divalent and trivalent form.

Preference is given to iron phosphite, iron hypophosphite, iron(III) chloride, iron(II) oxide, iron(II,III) oxide, iron(III) oxide, iron(II) hydroxide, iron(II) sulfate hydrate, iron(II) sulfate heptahydrate, iron(III) hydroxide, iron(II) titanate, iron(II) phosphate, iron(III) phosphate, iron(III) phosphate dihydrate, iron(III) phosphate tetrahydrate, iron(III) pyrophosphate, and metallic iron.

It is preferable that the ratio of iron to P source is from 1 mol of Fe:62 500 mol of P to 1 mol of Fe:3*10⁷ mol of P.

Preference is given to elements of main group II of the periodic table of the elements. Particular preference is given to calcium.

Preference is given to calcium hypophosphite, calcium carbonate, calcium hydrogen carbonate, calcium chloride, calcium chloride dihydrate, calcium chloride hexahydrate, calcium phosphate, dicalcium phosphate, tricalcium phosphate, monocalcium phosphate, tribasic calcium phosphate, dibasic calcium phosphate dihydrate, monobasic calcium phosphate hydrate, calcium fluoro phosphate, calcium hydroxide, calcium oxide, calcium oxalate, calcium pyrophosphate, calcium sulfate, calcium sulfate hemihydrate, calcium sulfate dihydrate, calcium titanate, calcium pyrophosphate, calcium polyphosphate, calcium superphosphate, or calcium hydrogen phosphate.

It is preferable that the ratio of calcium to P source is from 1 mol of Ca:192 mol of P to 1 mol of Ca:57 600 mol of P, particularly from 1 mol of Ca:1920 mol of P to 1 mol of Ca:23 040 mol of P.

Preferred selectivity controllers are hindered phenols, such as 2,6-di-tert-butyl-4-methylphenol (BHT). Preference is given to 2-tert-butyl-4-methylphenol, 2,5-di-tert-butyl-4-methoxyphenol, 2,6-di-tert-butyl-4-methoxyphenol, 2-tert-butyl-5-methylphenol, 2-tert-butyl-6-methylphenol, 2,6-di-tert-butyl-4-methylphenol, 2,4-dimethyl-6-tert-butylphenol, 2,4-dimethyl-6-tert-butylphenol, 2,4-dimethyl-6-tert-butylphenol, and 2,6-di-tert-butyl-4-methylphenol, 2,6-di-tert-butylphenol, 2,2-methylenebis(4-methyl-6-tert-butylphenol), 2-butyl-4,6-dimethylphenol; 2,6-di-tert-butyl-4-n-butylphenol; 2,6-di-tert-butyl-4-isobutylphenol; 2,6-dicyclopentyl-4-methylphenol; 2,6-dioctadecyl-4-methylphenol; 2,4,6-tricyclohexylphenol; 2,6-di-tert-butyl-4-methoxymethylphenol, 2,4-di-tert-butylpyrocatechol, tert-butylpyrocatechol, 2,2′-methylenebis(4-methyl-6-tert-butylphenol), 4,4′-methylenebis(2,6-di-tert-butylphenol), 4,4′-thiobis(2-tert-butyl-5-5-methylphenol).

Preferred hindered phenols are esterified hindered phenols, such as pentaerythritol tetrakis[3-(3,5-di-tert-butyl-4-hydroxyphenyl)propionate].

Other suitable compounds are alkylated monophenols, 2,6-di-tert-butyl-4-ethylphenol, 2,6-dioctadecyl-4-methylphenol, 2,6-dinonyl-4-methylphenol, 2,4-dimethyl-6-(1′-methylundec-l′-yl)phenol, 2,4-dimethyl-6-(1′-methylheptadecyl)phenol, 2,4-dimethyl-6-(1′-methyltridecyl)phenol, and mixtures thereof.

Particular preference is given to hydroquinones, alkylated hydroquinones, and hydroquinone monomethyl ethers are monomethylether of hydroquinone (4-methoxyphenol, MEHQ), hydroxyquinone dimethyl ether, 4-phenoxyphenol, hydroquinone, 2,6-di-tert-butyl-4-methoxyphenol, 2,5-di-tert-butyl-hydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, and bis(3,5-di-tert-butyl-4-hydroxyphenyl) adipate.

Particularly preferred phosphites or phosphonites are tris-4-tert-butylphenyl phosphite, tris-2,4-di-tert-butylphenyl phosphite, bis(4-tert-butylphenyl) 2,4-di-tert-butylphenyl phosphite, bis(2,4-di-tert-butylphenyl) 4-tert-butylphenyl phosphite, bis(2,4-di-tert-butyl-6-methylphenyl) pentaerythritol diphosphite, tris-4-tert-pentylphenyl phosphite, tris-2,4-di-tert-pentylphenyl phosphite, bis(4-tert-pentylphenyl) 2,4-di-tert-pentylphenyl phosphite, and bis(2,4-di-tert-pentylphenyl) 4-tert-pentylphenyl phosphite, and tris(nonylphenyl) phosphite.

Preferred phosphites are trilauryl, tributyl, trioctyl, tridecyl, tridodecyl, triphenyl, octyl diphenyl, dioctyl phenyl, tri(octylphenyl), tribenzyl, butyl dicresyl, octyl di(octylphenyl), tris(2-ethylhexyl), tritolyl, tris(2-cyclohexylphenyl), tri[alpha]naphthyl, tris(phenylphenyl), tris(2-phenylethyl), tris(dimethylphenyl), tricresyl, and tris(nonylphenyl) phosphite, triphenyl phosphite, diphenyl decyl phosphite, didecyl phenyl phosphite, and tristearyl sorbitol triphosphite, and tetradodecyl dipropylene glycol diphosphite, and tetradecyl pentaerythritol diphosphites, tetradodecyl pentaerythritol diphosphite, diisodecyl pentaerythritol diphosphite; 2,2-methylenebis(4,6-di-tert-butylphenyl) octyl phosphite; bis(2,4-di-tert-butylphenyl) pentaerythritol diphosphites; (2,6-di-tert-butyl-4-methylphenyl) pentaerythritol diphosphite; isodecyloxy pentaerythritol diphosphite; bis(2,4-di-tert-butyl-6-methyl phenyl) pentaerythritol diphosphite; bis(2,4,6-tri-tert-butylphenyl) pentaerythritol diphosphite; tristearyl sorbitol triphosphite; trioctadecyl phosphite; distearyl pentaerythritol diphosphite; tetrakis(2,4-di-tert-butylphenyl) 4,4′-biphenylene diphosphonite.

Phosphites and phosphonites, e.g. tris(nonylphenyl) phosphite, trilauryl phosphite, trioctadecyl phosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, bisisodecyloxy pentaerythritol diphosphite, bis(2,4-di-tert-butyl-6-methylphenyl) pentaerythritol diphosphite, 6-isooctyloxy-2,4,8,10-tetra-tert-butyl-12H-dibenzo[d,g]-1,3,2-dioxaphosphocin, 6-fluoro-2,4,8,10-tetra-tertbutyl-12-methyl-dibenzo[d,g]-1,3,2-dioxaphosphocin, bis(2,4-di-tert-butyl-6-methylphenyl) methyl phosphite, and bis(2,4-di-tert-butyl-6-methylphenyl)ethyl phosphite.

Preference is given to triphenyl phosphate; diphenyl alkyl phosphate; phenyl dialkyl phosphate; tris(nonylphenyl) phosphate; trilauryl phosphate; tris(2,4-di-tert-butylphenyl) phosphate; 6-isooctyloxy-2,4,8,10-tetra-tert-butyl-12-H-dibenzo[d,g]-1,3,2-d ioxaphosphocin; 6-fluoro-2,4,8,10-tetra-tert-butyl-1-2-methyldibenzo[d,g]-1,3,2-dioxaphosphocin; (2,4-di-tert-butyl-6-methylphenyl) methyl phosphate; (2,4-di-tert-butyl-6-methylphenyl)ethyl phosphates.

Particularly preferred sterically hindered amines are sterically hindered amine light stabilizers (HALS).

Sterically hindered amines, such as bis(2,2,6,6-tetramethylpiperidyl) sebacate, bis(2,2,6,6-tetramethylpiperidyl) succinate, bis(1,2,2,6,6-pentamethylpiperidyl) sebacate, bis(1,2,2,6,6-pentamethlypiperidyl) n-butyl-3,5-di-tert-butyl-4-hydroxybenzylmalonate, condensate of 1-hydroxyethyl-2,2,6,6-tetramethyl-4-hydroxypiperidine and succinic acid, condensate of N,N′-bis(2,2,6,6-tetramethyl-4-piperidyl)hexamethylenediamine and 4-tert-octylamino-2,6-dichloro-1,3,5-s-triazine, tris(2,2,6,6-tetramethyl-4-piperidyl) nitrilotriacetate, tetrakis(2,2,6,6-tetramethyl-4-piperidyl) 1,2,3,4-butanetetraoate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl) 2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl) sebacate, bis(1-octyloxy-2,2,6,6-tetramethylpiperidyl) succinate, condensate of N,N′-bis(2,2,6,6-tetramethyl-4-piperidyl)hexamethylenediamine and 4-morpholino-2,6-dichloro-1,3,5-triazine, condensate of 2-chloro-4,6-di(4-n-butylamino-2,2,6,6-tetramethylpiperidyl)-1,3,5-triazine and 1,2-bis(3-aminopropylamino)ethane, condensate of 2-chloro-4,6-di(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl)-1-(2,2,6,6-tetramethyl)-4-piperidyl)pyrrolidine-2,5-dione, and 3-dodecyl-1-(1,2,2,6,6-pentamethyl-4-piperidyl)pyrrolidine-2,5-dione.

Preferred aromatic amines are p-phenylenediamines, such as dioctyldiphenyldiamine, dinonyldiphenyldiamine, phenyl-alpha-naphthylamine, N,N′-di-2-butyl-1,4-phenylenediamine, and N,N-dibutyl-p-phenylendiamine.

Preferred phenothiazines are unsubstituted phenothiazine and unsubstituted phenothiazine 5-oxide or its hydrohalides, preferably its hydrochlorides.

Typical substituents of substituted phenothiazines are alkyl groups, alkoxy groups, aryl groups, carboxy groups, carboxylic ester groups, carboxamide groups, halogen atoms, hydroxy groups, nitro groups, and combinations thereof.

Preference is given to phenothiazine, 3-phenylphenothiazine, N-phenylphenothiazine, phenothiazine 5-oxide, 10,10′-diphenylphenothiazine, N-benzoylphenothiazine, 7-benzoylphenothiazine, 3,7-difluorophenothiazine, N-ethylphenothiazine, 2-acetylphenothiazine, 3,7-dioctylphenothiazine, N-methylphenothiazine 5-oxide, N-acetylphenothiazine, N-(2-diethylaminoethyl)phenothiazine, N-(2-dimethylaminopropyl)phenothiazine, N-(2-dimethylaminopropylphenothiazine) hydrochlorides, N-octadecylphenothiazine and N-propylphenothiazine.

Preferred organosulfur compounds are hydroxylated thiodiphenyl ethers, such as 2,2′-thiobis(6-tert-butyl-4-methylphenol); 2,2′-thiobis(4-octylphenol); 4,4′-thiobis(6-tert-butyl-3-methylphenol); 2-methyl-4-isothiazolin-3-one, lauryl thiopropionate, and salts of dialkyldithiocarbamic acid.

It is preferable that the ratio of stabilizer to P source is from 1 mol:13 mol of P to 1 mol:1 341 500 mol of P, particularly from 1 mol:134 mol of P to 1 mol:13 415 mol of P.

It is preferable that the phosphorus-containing flame retardant comprises from 70 to 99.9% by weight of phosphorus-containing mixture of the invention and from 0.1 to 30% by weight of one or more polymer additives.

It is preferable that the average particle size of the phosphorus-containing flame retardant is from 0.1 to 1700 μm, and that its residual moisture content is from 0.01 to 9% by weight.

The residual moisture content of the phosphorus-containing mixture of the invention is from 0.01 to 9%, preferably from 0.05 to 0.5%.

The invention also provides polymer molding compositions comprising
from 1 to 40% by weight of the phosphorus-containing mixture of the invention
from 1 to 99% by weight of polymer or a mixture of these
from 0 to 60% by weight of polymer additives
from 0 to 60% by weight of filler.

Preferred polymer additives for flame-retardant polymer molding compositions and flame-retardant polymer moldings are UV absorbers, light stabilizers, lubricants, colorants, antistatic agents, nucleating agents, fillers, and/or synergists.

The invention also provides polymer moldings, polymer films, polymer filaments, and polymer fibers comprising
from 1 to 40% by weight of the phosphorus-containing mixture of the invention
from 1 to 99% by weight of polymer or a mixture of these
from 0 to 60% by weight of polymer additives
from 0 to 60% by weight of filler.

The invention further provides polymer moldings, polymer films, polymer filaments, and polymer fibers comprising
from 1 to 50% by weight of the phosphorus-containing mixture of the invention
from 1 to 99% by weight of polystyrene-based polymer or a mixture of these
from 0 to 60% by weight of polymer additives
from 0 to 60% by weight of filler.

It is preferable in the invention to use the flame-retardant polymer moldings of the invention as lamp parts, such as lamp sockets and lamp holders, plugs and multipoint connectors, coil formers, casings for capacitors or contactors, and circuit-breakers, relay housings, and reflectors.

The invention also provides an intumescent flame-retardant coating comprising from 1 to 50% of the phosphorus-containing mixture of the invention, from 0 to 60% of ammonium polyphosphate, and from 0 to 80% by weight of binders, foam-formers, fillers, and polymer additives.

It is preferable that the polymers derive from the group of the thermoplastic polymers, such as polyesters, polystyrene, or polyamide, and/or of the thermoset polymers.

It is preferable that the polymers involve polymers of mono- and diolefins, for example polypropylene, polyisobutylene, poly-1-butene, poly-4-methyl-1-pentene, polyisoprene, or polybutadiene, or polymers of cycloolefins, e.g. of cyclopentene or norbornene; or polyethylene (if appropriate crosslinked), e.g. high-density polyethylene (HDPE), high-density high-molecular-weight polyethylene (HDHMWPE), high-density ultrahigh-molecular-weight polyethylene (HDUHMWPE), medium-density polyethylene (MDPE), low-density polyethylene (LDPE), linear low-density polyethylene (LLDPE), branched low-density polyethylene (VLDPE), or else a mixture of these.

It is preferable that the polymers involve copolymers of mono- and diolefins with one another or with other vinyl monomers, e.g. ethylene-propylene copolymers, linear low-density polyethylene (LLDPE), or a mixture of this with low-density polyethylene (LDPE), or are propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers, or their copolymers with carbon monoxide, or ethylene-acrylic acid copolymers or their salts (ionomers), or else terpolymers of ethylene with propylene and with a diene, such as hexadiene, dicyclopentadiene, or ethylidenenorbornene; or else mixtures of these copolymers with one another, e.g. polypropylene/ethylenepropylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, or alternating or random polyalkylene/carbon monoxide copolymers, or a mixture of these with other polymers, e.g. with polyamides.

The polymers are preferably hydrocarbon resins (e.g. C₅-C₉), inclusive of hydrogenated modifications thereof (e.g. tackifier resins), or a mixture of polyalkylenes and starch.

The polymers preferably involve polystyrene (polystyrene 143E (BASF), poly(p-methylstyrene), poly(alpha-methylstyrene)).

The polymers preferably involve copolymers of styrene or alpha-methylstyrene with dienes or with acrylic derivatives, e.g. styrene-butadiene, styrene-acrylonitrile, styrene-alkyl methacrylate, styrene-butadiene-alkyl acrylate, and styrene-butadiene-alkyl methacrylate, styrene-maleic anhydride, styrene-acrylonitrile-methyl acrylate; mixtures of high impact resistance composed of styrene copolymers and of another polymer, e.g. of a polyacrylate, of a diene polymer, or of an ethylene-propylene-diene terpolymer; or else block copolymers of styrene, e.g. styrene-butadiene-styrene, styrene-isoprene-styrene, styrene-ethylene/butylene-styrene, or styrene-ethylene/propylene-styrene.

The polymers preferably involve graft copolymers of styrene or alpha-methylstyrene, e.g. styrene on polybutadiene, styrene on polybutadiene-styrene copolymers or on polybutadiene-acrylonitrile copolymers, styrene and acrylonitrile (or methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates or alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, or else a mixture of these, e.g. those known as ABS polymers, MBS polymers, ASA polymers, or AES polymers.

It is preferable that the styrene polymers involve a rather coarse-pore foam, such as EPS (expanded polystyrene), e.g. Styropor (BASF), and/or a finer-pore foam, such as XPS (extruded rigid polystyrene foam), e.g. Styrodur (BASF). Preference is given to polystyrene foams such as Austrotherm XPS, Styrofoam (Dow Chemical), Floormate, Jackodur, Lustron, Roofmate, Styropor, Styrodur, Styrofoam, Sagex, and Telgopor.

It is preferable that the polymers involve halogen-containing polymers, e.g. polychloroprene, chlorinated rubber, chlorinated and brominated copolymer derived from isobutylene-isoprene (halobutyl rubber), chlorinated or chlorosulfonated polyethylene, copolymers of ethylene and of chlorinated ethylene, epichlorohydrinhomopolymers, epichlorohydrincopolymers, and in particular polymers derived from halogen-containing vinyl compounds, e.g. polyvinyl chloride, polyvinylidene chloride, polyvinyl fluoride, polyvinylidene fluoride; or else copolymers of these, e.g. vinyl chloride-vinylidene chloride, vinyl chloride-vinyl acetate, or vinylidene chloride-vinyl acetate.

The preferred polymers are polymers which derive from alpha-beta-unsaturated acids and from their derivatives, e.g. polyacrylates and polymethacrylates, butyl-acrylate-impact-modified polymethyl methacrylates, polyacrylamides, and polyacrylonitriles, and copolymers of the monomers mentioned with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers, or acrylonitrile-alkyl methacrylate-butadiene terpolymers.

It is preferable that the polymers involve polymers which derive from unsaturated alcohols and amines or from their acyl derivatives or from their acetals, e.g. polyvinyl alcohol, polyvinyl acetate, stearate, benzoate, maleate, polyvinyl butyral, polyallyl phthalate, polyallylmelamine; and also their copolymers with olefins.

It is preferable that the polymers involve homo- and copolymers of cyclic ethers, e.g. polyalkylene glycols, polyethylene oxide, polypropylene oxide, or their copolymers with bisglycidyl ethers.

It is preferable that the polymers involve polyacetals, such as polyoxymethylene, and also those polyoxymethylenes which contain comonomers, e.g. ethylene oxide; and polyacetals modified by thermoplastic polyurethanes, modified by acrylates, or modified by MBS.

It is preferable that the polymers involve polyphenylene oxides and polyphenylene sulfides, and their mixtures with styrene polymers or with polyamides.

It is preferable that the polymers involve polyurethanes which derive on the one hand from polyethers, from polyesters, or from polybutadienes having terminal hydroxy groups and on the other hand from aliphatic or aromatic polyisocyanates, preference also being given to precursors of these.

It is preferable that the polymers involve polyamides and copolyamides which derive from diamines and from dicarboxylic acids, and/or from aminocarboxylic acids, or from the corresponding lactams, e.g.
nylon-2/12,
nylon-4 (poly-4-aminobutyric acid, DuPont),
nylon-4/6 (poly(tetramethyleneadipamide), DuPont),
nylon-6 (polycaprolactam, poly-6-aminohexanoic acid, DuPont, Akulon K122, DSM; Zytel 7301, DuPont; Durethan B 29, Bayer),
nylon-6/6 (poly(N,N′-hexamethyleneadipamide), DuPont, Zytel 101, DuPont; Durethan A30, Durethan AKV, Durethan AM, Bayer; Ultramid A3, BASF),
nylon-6/9 (poly(hexamethylenenonanediamide), DuPont),
nylon-6/10 (poly(hexamethylenesebacamide), DuPont),
nylon-6/12 (poly(hexamethylenedodecanediamide), DuPont),
nylon-6/66 (poly(hexamethyleneadipamide-co-caprolactam), DuPont),
nylon-7 (poly-7-aminoheptanoic, DuPont),
nylon-7,7 (polyheptamethylenepimelamide, DuPont), nylon-8 (poly-8-aminooctanoic acid, DuPont),
nylon-8,8 (polyoctamethylenesuberamide, DuPont), nylon-9 (poly-9-aminononanoic acid, DuPont),
nylon-9,9 (polynonamethyleneazelamide, DuPont),
nylon-10 poly-10-aminodecanoic acid, DuPont),
nylon-10,9 (poly(decamethyleneazelamide), DuPont),
nylon-10,10 (polydecamethylenesebacamide, DuPont),
nylon-11 (poly-11-aminoundecanoic acid, DuPont),
nylon-12 (polylauryllactam, DuPont, Grillamid L20, Ems Chemie),
   aromatic polyamides derived from m-xylene, diamine, and adipic acid; polyamides prepared from hexamethylenediamine and iso- and/or terephthalic acid

(polyhexamethyleneisophthalamide or polyhexamethyleneterephthalamide), and, if appropriate, from an elastomer as modifier, e.g. poly-2,4,4-trimethylhexamethyleneterephthalamide or poly-m-phenyleneisophthalamide; block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol; or else copolyamides or polyamides modified by EPDM or modified by ABS; or else polyamides condensed during processing (“RIM polyamide systems”).

It is preferable that the polymers involve polyureas, polyimides, polyamideimides, polyetherimides, polyesterimides, polyhydantoins, and polybenzimidazoles.

It is preferable that the polymers involve polyesters which derive from dicarboxylic acids and from dialcohols, and/or from hydroxycarboxylic acids, or from the corresponding lactones, e.g. polyethylene terephthalate, polybutylene terephthalate (Celanex 2500, Celanex 2002, Celanese; Ultradur, BASF), poly(1,4-dimethylolcyclohexane terephthalate), polyhydroxybenzoates, and also block polyetheresters which derive from polyethers having hydroxy end groups; and also polyesters modified by polycarbonates or modified by MBS.

It is preferable that the polymers involve polycarbonates and polyester carbonates.

It is preferable that the polymers involve polysulfones, polyether sulfones, and polyether ketones.

It is preferable that the polymers involve crosslinked polymers which derive from aldehydes on the one hand and from phenols, urea or melamine on the other hand, e.g. phenol-formaldehyde resins, urea-formaldehyde resins, and melamine-formaldehyde resins.

It is preferable that the polymers involve drying and non-drying alkyd resins.

It is preferable that the polymers involve unsaturated polyester resins which derive from copolyesters of saturated or of unsaturated dicarboxylic acids with polyhydric alcohols, and also from vinyl compounds as crosslinking agents, the halogen-containing, flame-retardant modifications of these also being preferred.

It is preferable that the polymers involve crosslinkable acrylic resins which derive from substituted acrylic esters, e.g. from epoxy acrylates, from urethane acrylates, or from polyester acrylates.

It is preferable that the polymers involve alkyd resins, polyester resins, and acrylate resins which have been crosslinked by melamine resins, by urea resins, by isocyanates, by isocyanurates, by polyisocyanates, or by epoxy resins.

It is preferable that the polymers involve crosslinked epoxy resins which derive from aliphatic, cycloaliphatic, heterocyclic, or aromatic glycidyl compounds, e.g. products of bisphenol A diglycidyl ethers, or of bisphenol F diglycidyl ethers, which are crosslinked by means of conventional hardeners, e.g. by means of anhydrides or of amines, with or without accelerators.

It is preferable that the polymers involve mixtures (polyblends) of the abovementioned polymers, e.g. PP/EPDM, polyamide/EPDM, or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylate, POM/MBS, PPO/HIPS, PPO/PA 6.6, and copolymers, PA/HDPE, PA/PP, PA/PPO, PBT/PC/ABS, or PBT/PET/PC.

Compounding assemblies which may be used for producing polymer molding compositions in the invention are single-screw extruders, e.g. from Berstorff GmbH, Hanover, or from Leistritz, Nuremberg.

Other compounding assemblies which may be used in the invention are multizone screw extruders with three-section screws and/or short-compression-section screws.

Other compounding assemblies which may be used in the invention are co-kneaders, e.g. from Coperion Buss Compounding Systems, Pratteln, Switzerland, e.g. MDK/E46-11D, and/or laboratory kneaders (MDK 46 from Buss, Switzerland with L=11D).

Other compounding assemblies which may be used in the invention are twin-screw extruders, e.g. from Coperion Werner & Pfleiderer GmbH & Co. KG, Stuttgart (ZSK 25, ZSK30, ZSK 40, ZSK 58, ZSK MEGA compounder 40, 50, 58, 70, 92, 119, 177, 250, 320, 350, 380), and/or from Berstorff GmbH, Hanover, or Leistritz Extrusionstechnik GmbH, Nuremberg.

Other compounding assemblies which may be used in the invention are ring extruders, e.g. from 3+Extruder GmbH, Laufen, with a ring of from three to twelve small screws which rotate around a static core, and/or planetary-gear extruders, e.g. from Entex, Bochum, and/or vented extruders, and/or cascade extruders, and/or Maillefer screws.

Compounding assemblies which may be used in the invention are compounders with counter-rotating twin screws, e.g. Compex 37 or Compex 70 from Krauss-Maffei Berstorff.

Effective screw lengths for the invention are from 20 to 40D in the case of single-screw extruders.

Effective screw lengths (L) in the invention in the case of multizone-screw extruders are 25D with feed section (L=10D), transition section (L=6D), metering section (L=9D).

Effective screw lengths in the invention in the case of twin-screw extruders are from 8 to 48D.

Preparation, processing and testing of flame-retardant plastics molding compositions and plastics moldings.

The flame-retardant components were mixed with the polymer pellets and optionally additives and incorporated in a twin-screw extruder (Leistritz LSM 30/34) at temperatures of from 230 to 260° C. (GRPBT) or from 260 to 280° C. (GRPA 66). The homogenized polymer strand is drawn off, cooled in a water bath, and then pelletized.

After adequate drying, the molding compositions were processed to give test specimens in an injection-molding machine (Aarburg Allrounder) at melt temperatures of from 240 to 270° C. (GRPBT) or from 260 to 290° C. (GRPA 66).

The UL 94 (Underwriters Laboratories) fire class was determined on test specimens of thickness 1.5 mm made of each mixture.

UL 94 fire classes are as follows:

V-0: after flame time never longer than 10 seconds, total of after flame times for ten flame applications not more than 50 seconds, no flaming drops, no complete combustion of the specimen, afterglow time for the specimen never longer than 30 seconds after end of flame application.

V-1: after flame time never longer than 30 seconds after end of flame application, total of after flame times for ten flame applications not more than 250 seconds, afterglow time for the specimens never longer than 60 seconds after end of flame application, other criteria as for V-0.

V-2: cotton indicator ignited by flaming drops; other criteria as for V-1.

Not classifiable (ncl): does not comply with fire class V-2.

### EXAMPLE 1

1 mol of sodium hypophosphite monohydrate, 2.5 mol of cyclohexene, and 0.5 mol of 96% H₂SO₄ are mixed, and a certain amount of water is removed at the water separator by distillation. The solids are removed by filtration and washed twice with cyclohexene. A yield of hypophosphrous acid is 95%. A total of 61 g of bisbenzoyl peroxide are admixed with the resultant emulsion at 83° C. at reflux over 6 h. The mixture comprises 0.2 ppm of iron in the form of iron(II) sulfate. The reaction solution is extracted with demineralized (demin.) water, and concentrated to saturation by evaporation, and solids are crystallized out. Drying at 20 mbar and 130° C. gives 178 g of product (83% yield, based on H₃PO₂ used). The composition of the product is

99.5 mol % of compound of the formula (1) in which R¹=R²=cyclohexyl,
0.1 mol % of compound of the formula (1) in which R¹=H and R²=cyclohexyl,
0.2 mol % of compound of the formula (1) in which R¹=OH and R²=cyclohexyl
0.1 mol % of compound of the formula (1) in which R¹=OH and R²=H
0.1 mol % of compound of the formula (1) in which R¹=R²=H.

### EXAMPLE 2

1 mol of H₃PO₂ (50% in H₂O) and 2 mol of cyclohexene are used as initial charge. Water is removed at the water separator at 83° C. by azeotropic distillation. 65 g of bisbenzoyl peroxide are dissolved in 2 mol of cyclohexene and metered into the system at 83° C. over 12 h. The mixture comprises 0.3 ppm of calcium in the form of calcium phosphite and 2.5 ppm of 4-methoxyphenol (MEHQ). The reaction solution is extracted with hot demin. water, and concentrated to saturation by evaporation, and solids are crystallized out. Drying at 20 mbar and 130° C. gives 196 g of product (85% yield). The composition of the product is

99.6 mol % of compound of the formula (1) in which R¹=R²=cyclohexyl,
0.1 mol % of compound of the formula (1) in which R¹=H and R²=cyclohexyl, sq0.1 mol % of compound of the formula (1) in which R¹=OH and R²=cyclohexyl, and
0.2 mol % of compound of the formula (1) in which R¹=OH and R²=H.

### EXAMPLE 3

1 mol of sodium hypophosphite monohydrate, 2.24 mol of cyclohexene, 236 g of methanol, and 6.3 g of tert-butyl peroxide are heated for 12 h to 150° C., with stirring, in an autoclave from Berghof. In two further steps respectively a further 6.3 g of tert-butyl peroxide are added and the system is heated to 150° C. for 12 h, with stirring. The solution comprises 1 ppm of iron in the form of iron hypophosphite. The reaction solution is concentrated to dryness by evaporation, and then 1 mol of 37% hydrochloric acid and 550 g of glacial acetic acid are admixed, the solids are removed by filtration, the solution is concentrated by evaporation, taken up with 900 g of heptane, and washed with demin. water, and 700 g of heptane are removed by distillation, and solids are crystallized out. Drying at 20 mbar and 130° C. for 15 h gives 205 g of product (89% yield). The composition of the product is

99.9 mol % of compound of the formula (1) in which R¹=R²=cyclohexyl, and
0.1 mol % of compound of the formula (1) in which R¹=OH and R²=cyclohexyl.

### EXAMPLE 4

0.1 mol of sodium hypophosphite monohydrate, 0.3 mol of cyclohexene, 150 g of glacial acetic acid, and 1.1 g of sodium peroxodisulfate are heated for 12 h to 150° C., with stirring, in an autoclave from Berghof. The following procedure was carried out twice: 1.1 g of sodium peroxodisulfate were added and the system was heated to 150° C. for 12 h, with stirring. The solution comprises 1.7 ppm of calcium in the form of calcium hypophosphite. For work-up, 0.1 mol of 37% hydrochloric acid is admixed, sodium chloride is removed by filtration, and the mixture is concentrated to dryness by evaporation. The residue is dissolved in 140 g of heptane and crystallized out. Drying at 20 mbar and 130° C. for 15 h gives 20 g of product (87% yield). The composition of the product is

99.9 mol % of compound of the formula (1) in which R¹=R²=cyclohexyl, and
0.1 mol % of compound of the formula (1) in which R¹=OH and R²=H.

### EXAMPLE 5

1 mol of sodium hypophosphite monohydrate, 426 g of demin. water, and 155 g of cyclohexene are used as initial charge in a glass autoclave from Büchi. After heating to 118° C., 17 g of sodium peroxodisulfate dissolved in 226 g of water are metered into the system over 6.5 h, with stirring. The solution comprises 9 ppm of calcium in the form of calcium chloride. 0.5 mol of 96% sulfuric acid is added to the reaction solution. The precipitated solids are removed by filtration and washed with demin. water. Drying at 20 mbar and 130° C. for 15 h gives 209 g of product (91% yield). The composition of the product is

99.8 mol % of compound of the formula (1) in which R¹=R²=cyclohexyl,
0.1 mol % of compound of the formula (1) in which R¹=H and R²=cyclohexyl, and
0.1 mol % of compound of the formula (1) in which R¹=R²=H.

### EXAMPLE 6

### 1 mol of sodium hypophosphite monohydrate, 426 g of demin. water, and 155 g of cyclohexene are used as initial charge in a glass autoclave from Büchi. After heating to 118° C., 30 g of Wako® V50 dissolved in 210 g of water are metered into the system over 6.5 h, with stirring. The solution comprises 2.6 ppm of phenothiazine. 1 mol of 37% hydrochloric acid and 680 g of cyclohexene are added to the reaction solution. The organic phase is extracted with demin. water, and then 450 g of solvent are removed by distillation. The precipitated solids are removed by filtration. Drying at 20 mbar and 130° C. for 15 h gives 200 g of product (87% yield). The composition of the product is

99.7 mol % of compound of the formula (1) in which R¹=R²=cyclohexyl,
0.2 mol % of compound of the formula (1) in which R¹=OH and R²=cyclohexyl, and
0.1 mol % of compound of the formula (1) in which R¹=R²=H.

### EXAMPLE 7

1 mol of sodium hypophosphite monohydrate, 323 g of demin. water, and 155 g of cyclohexene are used as initial charge in a glass autoclave from Büchi. After heating to 118° C., 55 g of sodium peroxodisulfate dissolved in 149 g of water are metered into the system over 21.3 h, with stirring. The solution comprises 0.3 ppm of iron in the form of iron hypophosphite, 4 ppm of calcium in the form of calcium hypophosphite, and 0.7 ppm of 2,6-di-tert-butyl-4-methylphenol (BHT). The precipitated solids are removed by filtration and washed with demin. water. Drying at 20 mbar and 130° C. for 15 h gives 191 g of product (83% yield). The composition of the product is

99.8 mol % of compound of the formula (1) in which R¹=R²=cyclohexyl,
0.1 mol % of compound of the formula (1) in which R¹=OH and R²=cyclohexyl, and
0.1 mol % of compound of the formula (1) in which R¹=OH and R²=H.

### EXAMPLE 8

1 mol of sodium hypophosphite monohydrate, 426 g of demin. water, and 835 g of cyclohexene, and 0.5 mol of H₂SO₄ are used as initial charge in a glass autoclave from Büchi. After heating to 118° C., 26 g of sodium peroxodisulfate dissolved in 133 g of water are metered into the system over 4 h, with stirring. The solution comprises 0.03 ppm of iron in the form of iron(II) chloride. The organic phase is isolated, and washed three times with 680 g of demin. water, and 450 g of solvent are removed by distillation. The precipitated solids are removed by filtration. Drying at 20 mbar and 130° C. for 15 h gives 191 g of product (83% yield). The composition of the product is

99.7 mol % of compound of the formula (1) in which R¹=R²=cyclohexyl,
0.1 mol % of compound of the formula (1) in which R¹=OH and R²=cyclohexyl,
0.1 mol % of compound of the formula (1) in which R¹=OH and R²=H, and
0.1 mol % of compound of the formula (1) in which R¹=H and R²=H.

### EXAMPLE 9

1 mol of sodium hypophosphite monohydrate, 426 g of demin. water, and 835 g of cyclohexene are used as initial charge in a glass autoclave from Bach'. After heating to 128° C., 55 g of sodium peroxodisulfate dissolved in 149 g of water are metered into the system over 21.3 h, with stirring. The solution comprises 0.07 ppm of iron in the form of iron(II) hypophosphite and 2 ppm of calcium in the form of calcium hypophosphite. The organic phase is isolated and washed with demin. water, and 450 g of solvent are removed by distillation. The precipitated solids are removed by filtration. Drying at 20 mbar and 130° C. for 15 h gives 198 g of product (86% yield). The composition of the product is

99.7 mol % of compound of the formula (1) in which R¹=R²=cyclohexyl,
0.1 mol % of compound of the formula (1) in which R¹=H and R²=cyclohexyl,
0.1 mol % of compound of the formula (1) in which R¹=OH and R²=cyclohexyl, and
0.1 mol % of compound of the formula (1) in which R¹=H and R²=H.

### EXAMPLE 10

1 mol of sodium hypophosphite monohydrate, 426 g of demin. water, 0.4 g of tetrasodium pyrophosphate, and 155 g of cyclohexene are used as initial charge in a glass autoclave from Büchi. After heating to 118° C., 26 g of sodium peroxodisulfate dissolved in 133 g of water are added over 4 h, with stirring. The solution comprises 25 ppm of calcium in the form of calcium pyrophosphate. Work-up of the reaction solution as in example 6 gave 195 g of product (85% yield). The composition of the product is

99.8 mol % of compound of the formula (1) in which R¹=R²=cyclohexyl,
0.1 mol % of compound of the formula (1) in which R¹=H and R²=cyclohexyl, and
0.1 mol % of compound of the formula (1) in which R¹=OH and R²=cyclohexyl.

### EXAMPLE 11

1 mol of sodium hypophosphite monohydrate, 426 g of demin water, 1.8 g of sodium stearate, and 155 g of cyclohexene are used as initial charge in a glass autoclave from BOchi. After heating to 118° C., 26 g of sodium peroxodisulfate dissolved in 133 g of water are metered into the system over 4 h, with stirring. The solution comprises 0.1 ppm of bis(2,4-di-tert-butyl-6-methylphenyl) pentaerythritol diphosphite. Work-up of the reaction solution as in example 3 gave 200 g of product (87% yield). The composition of the product is

99.8 mol % of compound of the formula (1) in which R¹=R²=cyclohexyl,
0.1 mol % of compound of the formula (1) in which R¹=H and R²=cyclohexyl, and
0.1 mol % of compound of the formula (1) in which R¹=OH and R²=H.

### EXAMPLE 12

### Comparison

1 mol of sodium hypophosphite monohydrate, 426 g of demin. water, 2.2 g of sodium dodecyl sulfate, and 155 g of cyclohexene are used as initial charge in a glass autoclave from Büchi. After heating to 118° C., 26 g of sodium peroxodisulfate dissolved in 133 g of water are metered into the system over 4 h, with stirring. Work-up of the reaction solution as in example 5 gave 205 g of product (89% yield). The composition of the product is 100 mol % of compound of the formula (1) in which R¹=R²=cyclohexyl.

### EXAMPLE 13

1 mol of sodium hypophosphite monohydrate, 426 g of demin. water, 155 g of cyclohexene, and 72 g of n-butanol are used as initial charge in a glass autoclave from Büchi. After heating to 118° C., 35 g of sodium peroxodisulfate dissolved in 135 g of water are metered into the system over 3.5 h, with stirring. The solution comprises 1.1 ppm of calcium in the form of calcium hypophosphite. Work-up of the reaction solution as in example 3 gave 205 g of product (89% yield). The composition of the product is

99.9 mol % of compound of the formula (1) in which R¹=R²=cyclohexyl, and
0.1 mol % of compound of the formula (1) in which R¹=H and R²=cyclohexyl.

### EXAMPLE 14

1 mol of sodium hypophosphite monohydrate, 291 g of cyclohexanol and 30 g of 96% sulfuric acid are used as initial charge in an autoclave from Berghof, and 6.3 g of tert-butyl peroxide are heated to 150° C. for 12 h, with stirring. In two further steps respectively a further 6.3 g of tert-butyl peroxide are added and heated to 150° C. for 12 h, with stirring. The solution comprises 119 ppm of lauryl thiopropionate. A further 0.2 mol of 96% sulfuric acid is added to the cooled reaction solution, and the solids are removed by filtration. The reaction solution is concentrated by evaporation, taken up with 900 g of heptane, and washed three times, each time with 900 g of demin. water, and 700 g of solvent are removed by distillation. The product crystallized out is dried at 20 mbar at 130° C. for 15 h, giving 196 g of product (85% yield). The composition of the product is

99.8 mol % of compound of the formula (1) in which R¹=R²=cyclohexyl, and
0.2 mol % of compound of the formula (1) in which R¹=R²=H.

### EXAMPLE 15

### Comparison

After adequate drying, polystyrene 143E (BASF) was processed to give test specimens (1.6 mm) in an injection-molding machine (Aarburg Allrounder) at melt temperatures of from 250 to 300° C. No fire test classification could be achieved in the UL 94 test, since complete combustion of the test specimens occurred.

### EXAMPLE 16

### Comparison

10% by weight of cyclohexylphosphinic acid from example 12 was mixed with 90% by weight of polymer pellets (polystyrene 143 E from BASF) and incorporated at temperatures from 250 to 300° C. in a twin-screw extruder (Leistritz LSM 30/34). The homogenized polymer strand was drawn off, cooled in a water bath, and then pelletized. After adequate drying, the molding compositions were processed to give test specimens in an injection-molding machine (Aarburg Allrounder) at melt temperatures of from 250 to 300° C. No classification was achieved in the UL 94 flame retardancy test.

### EXAMPLE 17

10% by weight of cyclohexylphosphinic acid from example 1 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 18

10% by weight of cyclohexylphosphinic acid from example 2 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 19

10% by weight of cyclohexylphosphinic acid from example 3 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 20

10% by weight of cyclohexylphosphinic acid from example 4 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 21

10% by weight of cyclohexylphosphinic acid from example 5 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 22

10% by weight of cyclohexylphosphinic acid from example 6 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 23

10% by weight of cyclohexylphosphinic acid from example 7 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 24

10% by weight of cyclohexylphosphinic acid from example 8 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 25

10% by weight of cyclohexylphosphinic acid from example 9 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 26

10% by weight of cyclohexylphosphinic acid from example 10 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 27

10% by weight of cyclohexylphosphinic acid from example 11 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 28

10% by weight of cyclohexylphosphinic acid from example 13 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 29

10% by weight of cyclohexylphosphinic acid from example 14 was mixed with 90% by weight of polymer pellets (polystyrene 143E from BASF) and, as in example 16, incorporated, pelletized, and processed to give test specimens. V-2 classification was achieved in the UL 94 flame retardancy test.

### EXAMPLE 30

100 g of pure DEN 438 resin (Dow Chemical) are used as initial charge in a 4-necked flask equipped with reflux condenser, temperature sensor, nitrogen supply, and stirrer, and residual water is removed in vacuo at 110° C. 30 g of product from example 6 are added at 130° C., with stirring. The temperature of the reaction mixture is increased to 160° C. and kept at that level for 2.5 h. The product is then decanted while hot, and cooled, and comprises 23.1% of dicyclohexylphosphinic acid. 100 parts of this EP resin are fused with 67 parts of phenyl novolak PF 0790 K04 from Hexion at T=150° C. to give a homogeneous mixture. 0.03 part of imidazole catalyst is added at 130° C. After stirring for a further 5-10 min., the homogeneous mixture is poured into an aluminum mold and then hardened for 2 h at 140° C. and 2 h at 200° C. in a drying oven, and UL 94 moldings are cut out from the molded sheet. The classification of the moldings with 13.8% by weight of product from example 6 in the fire test is V-0.

### EXAMPLE 31

30% by weight of product from example 3 are processed with 70% by weight of Celanex® 2300 GV 1/30 (glassfiber-reinforced PBT from Celanese) at temperatures of 250° C. in a twin-screw extruder (Leistritz LSM 30/34) to give a flame-retardant polymer molding composition. The homogenized polymer strand is drawn off, cooled in a water bath, and then pelletized. After adequate drying, the molding composition was processed to give test specimens in an injection-molding machine (Aarburg Allrounder) at melt temperatures of 260° C. V-0 classification was achieved in the UL 94 flame retardancy test.

### EXAMPLE 32

30% by weight of product from example 7 with 50% by weight of Zytel 7301 polyamide from DuPont and 20% by weight of Vetrotex EC 10983 glass fibers from St Gobain in a twin-screw extruder (Leistritz LSM 30/34) at temperatures of 270° C. to give a flame-retardant polymer molding composition. The homogenized polymer strand is drawn off, cooled in a water bath, and then pelletized. After adequate drying, the molding composition was processed to give test specimens in an injection-molding machine (Aarburg Allrounder) at melt temperatures of 280° C. V-0 classification was achieved in the UL 94 flame retardancy test.

### EXAMPLE 33

Plexiglas® 7H standard molding composition from Evonik Röhm GmbH was mixed with a copolymer of 99% by weight of MMA and 1% by weight of methyl acrylate, and also 10% of product from example 2. For this, the two polymer pellets and the flame retardant were respectively extruded twice in a 15 mm Stork single-screw extruder at 230° C., and pelletized. The glass-clear, colorless compounded materials were processed to give test specimens. V-0 classification was achieved in the UL 94 flame retardancy test.

The overall result is that the flame retardants of examples 1 to 11 and 13 and 14 of the invention can achieve UL 94 classification or higher UL 94 classification, whereas the performance of the product of example 12, obtainable industrially, is substantially poorer (no UL 94 classification). V-0 is not achieved in the prior art hitherto disclosed. At a given dosage, the flame retardants of examples 1 to 11 and 13 and 14 of the invention are therefore markedly superior.

| | | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| | | Example [g/mol] | | | | | | | | | | | | | |
| NHP-MH | [106.0 g] | 106 | | 106 | 10.6 | 106 | 106 | 106 | 106 | 106 | 106 | 106 | 106 | 106 | 106 |
| H₂SO₄ | [98.0 g] | 51 | | | | | | | | | | | | | 30 |
| H₃PO₂ | [66.0 g] | | 132 | | | | | | | | | | | | |
| H₂O | | | | | 652 | 636 | 472 | 559 | 575 | 559 | 559 | 559 | 561 | | |
| Cyclohexene | [82.2 g] | 312 | 329 | 184 | 25 | 155 | 155 | 155 | 835 | 835 | 155 | 155 | 155 | 155 | |
| Cyclohexanol | [100.2 g] | | | | | | | | | | | | | | 291 |
| Bisbenzoyl | [242.2 g] | 61 | 65 | | | | | | | | | | | | |
| peroxide | | | | | | | | | | | | | | | |
| tert-butyl | [146.2 g] | | | 18.9 | | | | | | | | | | | 18.9 |
| peroxide | | | | | | | | | | | | | | | |
| Na₂S₂O₈ | [238.1 g] | | | | 3.3 | 17 | | 55 | 26 | 55 | 26 | 26 | 26 | 35 | |
| Wako V50 | [271.2 g] | | | | | | 30 | | | | | | | | |
| Tetrasodium | [265.9 g] | | | | | | | | | | 0.4 | | | | |
| pyrophosphate | | | | | | | | | | | | | | | |
| Sodium stearate | [306.5 g] | | | | | | | | | | | 1.8 | | | |
| Sodium dodecyl | [288.4 g] | | | | | | | | | | | | 2.2 | | |
| sulfate | | | | | | | | | | | | | | | |
| Butanol | [74.1 g] | | | | | | | | | | | | | 71.809 | |
| MeOH | [32.0 g] | | | 236 | | | | | | | | | | | |
| Hac | [60.1 g] | | | | 150 | | | | | | | | | | |
| | | Example | | | | | | | | | | | | | |
| mol of P | | 1 | 1 | 1 | 0.1 | 1 | 1 | 1 | 1 | 1 | 1 | 1 | 1 | 1 | 1 |
| mol of H₂O/mol | | 0.28 | 0.28 | 1.00 | 1.00 | 37 | 36 | 27 | 32 | 33 | 32 | 32 | 32 | 32 | 1 |
| of P | | | | | | | | | | | | | | | |
| mol of additive/ | | | | 7.4 | 25.0 | | | | | | 0.002 | 0.006 | 0.008 | 0.969 | |
| mol of P | | | | | | | | | | | | | | | |
| mol of olefin/mol | | 4.0 | 4.0 | 2.2 | 3.2 | 2.0 | 2.0 | 2.0 | 10.7 | 10.7 | 2.0 | 2.0 | 2.0 | 2.0 | 0.0 |
| of P | | | | | | | | | | | | | | | |
| Init * 100 | | | | 12.9 | 13.9 | 7.0 | 11.0 | 22.9 | 10.9 | 23.1 | 11.0 | 11.0 | 11.0 | 14.5 | 0.0 |
| Temperature | [° C.] | 83 | 83 | 150 | 150 | 118 | 118 | 118 | 118 | 128 | 118 | 118 | 118 | 118 | 118 |
| Time | [h] | 6.0 | 12.0 | 36.0 | 26.0 | 6.5 | 6.5 | 21.3 | 4.0 | 21.3 | 4.0 | 4.0 | 4.0 | 3.5 | 3.5 |
| | | Example [g/mol] | | | | | | | | | | | | | |
| Product | [230.2 g] | 178 | 196 | 205 | 20 | 209 | 200 | 191 | 200 | 198 | 196 | 200 | 205 | 205 | 205 |

1. A phosphorus-containing mixture comprising
a) 50 to 100 mol % of compounds of the formula (1) 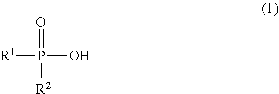
wherein R¹ and R² are identical or different and are C₆-C₉-alkyl,
b) 0 to 50 mol % of compounds of the formula (1), wherein R¹ is H and R² is C₆-C₉-alkyl,
c) 0 to 50 mol % of compounds of the formula (1), wherein R¹ is OH and R² is C₆-C₉-alkyl,
d) 0 to 50 mol % of compounds of the formula (1), wherein R¹ is OH and R² is H, and
e) 0 to 50 mol % of compounds of the formula (1), wherein R¹ is H and R² is H,
where the sum of a), b), c), d), and e) is 100 mol %.

2. The mixture as claimed in claim 1, comprising
a) 50 to 99.9 mol % of compounds of the formula (1), wherein R¹ and R² are identical or different and are C₆-C₉-alkyl,
b) 0.05 to 25 mol % of compounds of the formula (1), wherein R¹ is H and R² is C₆-C₉-alkyl, and
c) 0.05 to 25 mol % of compounds of the formula (1), wherein R¹ is H and R² is H.

3. The mixture as claimed in claim 1, comprising
a) 50 to 99.9 mol % of compounds of the formula (1), wherein R¹ and R² are identical or different and are C₆-C₉-alkyl,
b) 0.05 to 25 mol % of compounds of the formula (1), wherein R¹ is OH and R² is C₆-C₉-alkyl, and
c) 0.05 to 25 mol % of compounds of the formula (1), wherein R¹ is OH and R² is H.

4. The mixture as claimed in claim 1, comprising
a) 50 to 99.8 mol % of compounds of the formula (1), wherein R¹ and R² are identical or different and are C₆-C₉-alkyl,
b) 0.05 to 12.5 mol % of compounds of the formula (1), wherein R¹ is H and R² is C₆-C₉-alkyl,
c) 0.05 to 12.5 mol % of compounds of the formula (1), wherein R¹ is OH and R² is C₆-C₉-alkyl,
d) 0.05 to 12.5 mol % of compounds of the formula (1), wherein R¹ is OH and R² is H, and
e) 0.05 to 12.5 mol % of compounds of the formula (1), wherein in which R¹ is H and R² is H.

5. The mixture as claimed in claim 1, wherein R¹ and R² are identical or different and are cyclic, isocyclic, open-chain, linear open-chain C₆-C₉-alkyl, branched open-chain C₆-C₉-alkyl or mixtures thereof.

6. The mixture as claimed in claim 1, wherein R¹ and R² are identical or different and are methylpentyl, methylcyclopentyl, dimethylpentyl, dimethylcyclopentyl, trimethylpentyl, trimethylcyclopentyl, hexyl, cyclohexyl, methylhexyl, methylcyclohexyl, dimethylhexyl, dimethylcyclohexyl, trimethylhexyl, trimethylcyclohexyl or mixtures thereof.

7. A process for producing a phosphorus-containing mixture, wherein the mixture includes
a) 50 to 100 mol % of compounds of the formula (1) 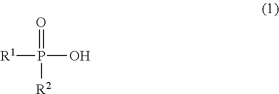
wherein R¹ and R² are identical or different and are C₆-C₉-alkyl,
b) 0 to 50 mol % of compounds of the formula (1), wherein R¹ is H and R² is C₆-C₉-alkyl,
c) 0 to 50 mol % of compounds of the formula (1), wherein R¹ is OH and R² is C₆-C₉-alkyl,
d) 0 to 50 mol % of compounds of the formula (1), wherein R¹ is OH and R² is H, and
e) 0 to 50 mol % of compounds of the formula (1), wherein R¹ is H and R² is H, where the sum of a), b), c), d), and e) is 100 mol %, comprising the step of reacting a phosphinate source, an olefin which is liquid at a temperature from 20 to 25° C., and a free-radical initiator, optionally with addition of an additive, in the presence of at least one selectivity controller in an aqueous medium.

8. The process as claimed in claim 7, wherein the phosphinate source is sodium hypophosphite, hypophosphorous acid, alkaline earth metal hypophosphite, elemental phosphorus, phosphorus trichloride or a mixture thereof.

9. The process as claimed in claim 7 erg, wherein the liquid olefin is pentene, cyclopentene, cyclopentadiene, hexene, methylhexene, dimethylhexene, trimethylhexene, methylhexadiene, cyclohexene, methylcyclohexene, dimethylcyclohexene, 1,3-cyclohexadiene, methyl-1,3-cyclohexadiene, dimethyl-1,3-cyclohexadiene, trimethyl-1,3-cyclohexadiene, 1,4-cyclohexadiene, methyl-1,4-cyclohexadiene, dimethyl-1,4-cyclohexadiene, or a mixture thereof.

10. The process as claimed in claim 7, wherein the at least one selectivity controller is selected from the group consisting of organic phosphites, organic phosphonites, sterically hindered amines, aromatic amines, sterically hindered phenols, alkylated monophenols, phenothiazines, organosulfur compounds, alkylthiomethylphenols, tocopherols, alkylidenebisphenols, O-/N- and S-benzyl compounds, hydroxybenzylated malonates, hydroquinones, alkylated hydroquinones, hydroxylated thiodiphenyl ethers, alkylidene bisphenols, hydroxybenzylaromatics, triazine compounds, benzylphosphonates, acylaminophenols, esters of beta-(3,5-di-tert-butyl-4-hydroxphenyl)propionic acid with mono- or polyhydric alcohols, esters of beta-(5-tert-butyl-4-hydroxy-3-methylphenyl)propionic acid with mono- or polyhydric alcohols, esters of beta-(3,5-dicyclohexyl-4-hydroxyphenyl)propionic acid with mono- or polyhydric alcohols, esters of 3,5-di-tert-butyl-4-hydroxyphenylacetic acid with mono- or polyhydric alcohols, amides of beta-(3,5-di-tert-butyl-4-hydroxyphenyl)propionic acid and mixtures thereof.

11. The process as claimed in claim 7, wherein the free-radical initiator is selected from the group consisting water-soluble peroxo compounds, azo compounds and mixtures thereof.

12. The process as claimed in claim 11, wherein the peroxo compounds are selected from the group consisting of potassium persulfate, sodium persulfate, ammonium persulfate, potassium peroxomonosulfate, sodium peroxomonosulfate, ammonium peroxomonosulfate, hydrogen peroxide, benzoyl peroxide, di-tert-butyl peroxide, dicumyl peroxide, 2,4-dichlorobenzoyl peroxide, decanoyl peroxide, lauryl peroxide, cumene hydroperoxide, pinene hydroperoxide, p-menthane hydroperoxide, tert-butyl hydroperoxide, acetylacetone peroxide, methyl ethyl ketone peroxide, succinic acid peroxide, dicetyl peroxydicarbonate, tert-butyl peroxyacetate, tert-butyl peroxymaleic acid, tert-butyl peroxybenzoate, acetylcyclohexylsulfonyl peroxide, performic acid, peracetic acid, 2,4-dichlorobenzoyl peroxide, decanoyl peroxide and mixtures thereof.

13. The process as claimed in claim 11, wherein the at least one azo compound is
2,2′-azobis[2-(5-methyl-2-imidazolin-2-yl)propane]dihydrochloride,
2,2′-azobis[2-(2-imidazolin-2-yl)propane]dihydrochloride,
2,2′-azobis[2-(2-imidazolin-2-yl)propane disulfate dihydrate,
2,2′-azobis(2-amidinopropane) hydrochloride,
2,2′-azobis[N-(2-carboxyethyl)-2-methylpropionamidine]tetrahydrate,
2,2′-azobis[2-(3,4,5,6-tetrahydropyrimidin-2-yl)propane]dihydrochloride,
2,2′-azobis{2-[1-(2-hydroxyethyl)-2-imidazolin-2-yl]propane}dihydrochloride,
2,2′-azobis[2-(2-imidazolin-2-yl)propane],
2,2′-azobis{2-methyl-N-[1,1-bis(hydroxymethyl)-2-hydroxyethyl]propionamide,
2,2′-azobis{2-methyl-N-[2-(1-hydroxybutyl)]propionamide}
2,2′-azobis[2-methyl-N-(2-hydroxyethyl)propionamide] or a mixture thereof.

14. The process as claimed in claim 7, wherein, after the reaction step, the resultant mixture is worked up by
a) admixing mineral acid with the resultant mixture, and
b) isolating the mixture thus obtained
and thereafter performing at least one of the following steps
c) washing the mixture with water;
d) drying the mixture;
e) grinding the mixture; and
f) sieving the mixture.

15. The process as claimed in claim 7, wherein, after the reaction step, the resultant mixture is worked up by
a) admixing mineral acid with the resultant mixture, and
b) admixing solvent with the resultant mixture, and isolating the resultant solvent phase,
and thereafter performing at least one of the following steps
c) extracting the solvent phase with water;
d) concentrating the solvent phase and crystallizing the mixture;
e) isolating the mixture;
f) washing the mixture with water;
g) drying the mixture;
h) grinding the mixture; and
i) sieving the mixture.

16. The process as claimed in claim 7, wherein, after the reaction step, the resultant mixture is worked up by
a) admixing mineral acid with the resultant mixture;
b) isolating the solid;
c) concentrating the resultant mixture by evaporation,
d) admixing solvent with the resultant residue from concentration by evaporation;
and thereafter performing at least one of the following steps
e) extracting the solvent phase with water;
f) concentrating the solvent phase and crystallizing the resultant mixture;
g) isolating the mixture;
h) drying the mixture;
i) grinding the mixture; and
j) sieving the mixture.

17. The process as claimed in claim 7, wherein, after the reaction step, the resultant mixture is worked up by
a) concentrating the resultant mixture by evaporation;
b) admixing solvent;
c) admixing mineral acid with the resultant mixture;
d) filtering the solid off from the solvent phase;
e) concentrating the solvent phase by evaporation;
f) admixing solvent with the resultant residue from concentration by evaporation;
and thereafter performing at least one of the following steps
g) extracting solvent phase 2 with water;
h) concentrating solvent phase 2 and crystallizing the mixture;
i) drying the mixture;
j) grinding the mixture; and
k) sieving the mixture.

18. A flame-retardant plastic molding composition comprising a phosphorus-containing mixture, wherein the phosphorus-containing mixture includes
a) 50 to 100 mol % of compounds of the formula (1) 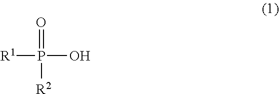
wherein R¹ and R² are identical or different and are C₆-C₉-alkyl,
b) 0 to 50 mol % of compounds of the formula (1), wherein R¹ is H and R² is C₆-C₉-alkyl,
c) 0 to 50 mol % of compounds of the formula (1), wherein R¹ is OH and R² is C₆-C₉-alkyl,
d) 0 to 50 mol % of compounds of the formula (1), wherein R¹ is OH and R² is H, and
e) 0 to 50 mol % of compounds of the formula (1), wherein R¹ is H and R² is H,
where the sum of a), b), c), d), and e) is 100 mol %, and
wherein the plastic is selected from the group consisting of HI (high-impact) polystyrene, polyphenylene ethers, polyamides, polyesters, polycarbonates, ABS (acrylonitrile-butadiene-styrene), PC/ABS (polycarbonate/Acrylonitrile-butadiene-styrene), polypropylene, polymethyl methacrylate (PMMA), XPS (extruded rigid polystyrene foam), EPS (expanded polystyrene), and PPE/HIPS (polyphenylene ether/HI polystyrene) plastics, and wherein the plastic molding composition includes from 50 to 98% by weight of the plastic and from 2 to 50% by weight of the phosphorus-containing mixture.

19. A polymer molding, polymer film, polymer filament, or polymer fiber comprising a phosphorus-containing mixture, wherein the phosphorus-containing mixture includes
a) 50 to 100 mol % of compounds of the formula (1) 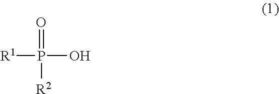
wherein R¹ and R² are identical or different and are C₆-C₉-alkyl,
b) 0 to 50 mol % of compounds of the formula (1), wherein R¹ is H and R² is C₆-C₉-alkyl,
c) 0 to 50 mol % of compounds of the formula (1), wherein R¹ is OH and R² is C₆-C₉-alkyl,
d) 0 to 50 mol % of compounds of the formula (1), wherein R¹ is OH and R² is H, and
e) 0 to 50 mol % of compounds of the formula (1), wherein R¹ is H and R² is H,
where the sum of a), b), c), d), and e) is 100 mol %, and
wherein the polymer is selected from the group consisting of HI (high-impact) polystyrene, polyphenylene ethers, polyamides, polyesters, polycarbonates, and ABS (acrylonitrile-butadiene-styrene), PC/ABS (polycarbonate/acrylonitrile-butadien-styrene), polyamide, polyester, polypropylene, polymethyl methacrylate (PMMA), XPS (extruded rigid polystyrene foam), EPS (expanded polystyrene), ABS and mixtures thereof, and wherein the polymer molding, polymer film, polymer filament or polymer fiber comprises from 50 to 98% by weight of the polymer and from 2 to 50% by weight of the phosphorus-containing mixture.
